(19) United States
(12) Patent Application Publication
(10) Pub. No.: US 2025/0231556 A1
(43) Pub. Date: Jul. 17, 2025

(54) HISTORY MANAGEMENT DEVICE AND PROGRAM

(71) Applicant: FANUC CORPORATION, Yamanashi (JP)

(72) Inventors: Zeyuan SUN, Yamanashi (JP); Yuta NAMIKI, Yamanashi (JP); Shoutarou OGURA, Yamanashi (JP)

(21) Appl. No.: 18/701,616

(22) PCT Filed: Nov. 4, 2021
(86) PCT No.: PCT/JP2021/040636

§ 371 Date: Apr. 16, 2024

(51) Int. Cl. G05B 23/02

(52) U.S. Cl. CPC G05B 23/0216

(57) ABSTRACT

Provided is a history management device for managing history information pertaining to the results of execution of a prescribed process by an industrial machine, the history management device comprising a display unit and a history display control unit that controls the display of history information on the display unit. The history display control unit reads history information from both a first storage unit that stores history information and a second storage unit that stores history information and has a property differing from that of the first storage unit, and the history display control unit simultaneously displays the history information on the display unit.

### FIELD

The present invention relates to a history management device and a computer program.

### BACKGROUND

A robot system configured to include an image processing device processing an image captured by a visual sensor and to perform, for example, handling of a target object by using a detection result of the target object by the visual sensor is known. For example, PTL 1 describes “an image processing system including: a relatively high-speed first storage unit 52 storing image capture information including image data captured by a visual sensor 51 and at least either of a processing result of the image data and machine control information at a time of image capture; a second storage unit 53 with a lower speed and a higher capacity relative to those of the first storage unit 52, the image capture information being transferred to the second storage unit 53 from the first storage unit 52; a storage control unit 54 controlling storage of the image capture information by the first storage unit 52 and transfer of the image capture information from the first storage unit 52 to the second storage unit 53; an image processing unit 55 calculating a position and an orientation of a workpiece W relative to the visual sensor 51 by processing the image data captured by the visual sensor 51; an input unit 56 to which an operator can input information; and a display unit 57 presenting information to the operator” (paragraph 0017).

PTL 2 describes “working equipment including: a control unit controlling operation; a volatile memory holding written information during operation of the control unit, history information about the working equipment being written into the volatile memory; and a rewritable nonvolatile memory, wherein the control unit includes an update processing unit configured to update history information in the volatile memory every time an event prompting update of the history information occurs and a write processing unit configured to perform write processing of writing the history information stored in the volatile memory into the nonvolatile memory when suspension of operating power supply to the control unit is anticipated” (claim 1).

PTL 3 describes that a command processing unit 141 in an electronic device determines a display starting position, based on display history stored by a display history storage unit 132, and a display control unit 142 displays, from a specified display starting position, image data supplied from the command processing unit 141 in response to a request from the command processing unit 141 (paragraphs 0040 and 0041).

PTL 4 describes “a robot controller including a program execution history data display device including: a means for storing information indicating an operation program execution history of a robot; a means for reading the program execution history information; and a means for displaying the read program execution history information on a display, wherein the program execution history information includes program name information for specifying an executed program, information for specifying an execution order of programs, information for specifying an execution part in the executed program, and information allowing distinction between forward execution and backward execution with regard to the execution part” (claim 1).

### CITATION LIST

### Patent Literature

[PTL 1] Japanese Unexamined Patent Publication (Kokai) No. 2021-5125A
[PTL 2] Japanese Unexamined Patent Publication (Kokai) No. 2017-45390A
[PTL 3] Japanese Unexamined Patent Publication (Kokai) No. 2021-12272A
[PTL 4] Japanese Unexamined Patent Publication (Kokai) No. H07-129220A

### SUMMARY

### Technical Problem

While a run time monitor screen may be configured by displaying a history temporarily saved in the first storage unit formed of a volatile memory, and an execution history screen may be configured by reading and displaying a history recorded in the second storage unit formed of a nonvolatile memory in the image processing system as described in PTL 1, the run time monitor screen and the execution history screen are generally displayed independently of each other. A history management device, a program, etc. that present history information in a style convenient for a user so as to enable the user to efficiently manage history information are desired.

### Solution to Problem

An embodiment of the present disclosure is a history management device for managing history information about an execution result of predetermined processing performed by an industrial machine, the history management device including: a display unit; and a history display control unit configured to control display of the history information on the display unit, wherein the history display control unit reads the history information from both a first storage unit storing the history information and a second storage unit with a characteristic different from that of the first storage unit, the second storage unit storing the history information, and simultaneously displays the read history information on the display unit.

Another embodiment of the present disclosure is a program for causing a processor in a computer to execute processing of reading history information about an execution result of processing performed by an industrial machine from both a first storage unit storing the history information and a second storage unit with a characteristic different from that of the first storage unit, the second storage unit storing the history information, rearranging the read history information in accordance with a predetermined rule, and simultaneously displaying the rearranged history information on a display screen.

### Advantageous Effects of Invention

The aforementioned configuration enables a user to centrally manage history information stored in the first storage unit and the second storage unit with characteristics different from each other and efficiently to perform checking and an operation on the history information.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating an entire configuration of a robot system including a history management device according to an embodiment.

FIG. 2 is a diagram illustrating a hardware configuration example of an image processing device, a robot controller, and a teach pendant.

FIG. 3 is a functional block diagram related to the image processing device, an external storage device, and the robot controller.

FIG. 4 is a diagram illustrating a history display screen as a first example related to history display.

FIG. 5 is a diagram illustrating a state in which a history image and details of an execution result are displayed.

FIG. 6 is a diagram illustrating a display example of a history display screen in an update suspension mode.

FIG. 7 is a flowchart illustrating history information display processing performed by a history display control unit.

### DESCRIPTION OF EMBODIMENTS

Next, embodiments of the present disclosure will be described with reference to drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

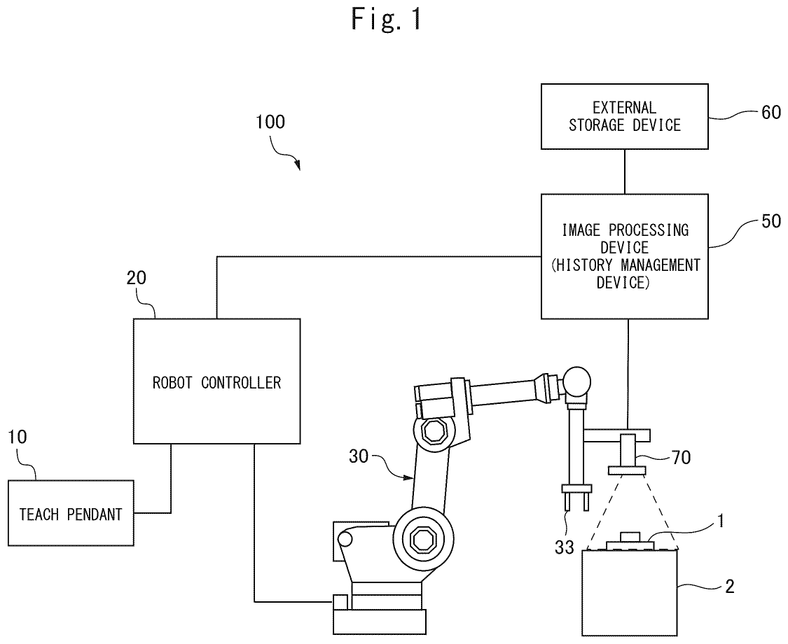

FIG. 1 is a diagram illustrating an entire configuration of a robot system 100 including a history management device according to an embodiment. The robot system 100 includes a robot 30 including an arm tip provided with a hand 33, a robot controller 20 controlling the robot 30, a teach pendant 10 connected to the robot controller 20, a visual sensor 70 attached to the arm tip of the robot 30, an image processing device 50, and an external storage device 60. The robot system 100 is a system configured to perform, by the visual sensor 70, predetermined processing (such as detection and determination) on a target object 1 (hereinafter described as a workpiece 1) placed on a workbench 2 and perform handling of the workpiece 1.

While the robot 30 as an industrial machine is assumed to be a vertical articulated robot, another type of robot such as a Cartesian robot, a SCARA robot, or a parallel link robot may be used. The robot controller 20 controls the operation of the robot 30 in accordance with an operation program loaded in the robot controller 20 or a command input from the teach pendant 10.

The image processing device 50 is connected to the robot controller 20. The image processing device 50 has a function of performing control of the visual sensor 70 and various types of image processing in accordance with commands sent from the robot controller 20. The image processing device 50 can detect the position of the workpiece 1 from an image captured by the visual sensor 70 and provide the detected position of the workpiece 1 to the robot controller 20. Thus, the robot controller 20 can execute, for example, picking-up of the workpiece 1 while correcting a teaching position by using the detected position. The image processing device 50 according to the present embodiment also has a function of storing and managing history information as an execution result of processing performed by the visual sensor 70 and therefore may be positioned as a history management device.

The visual sensor 70 may be a camera capturing a gray image and/or a color image, or a stereo camera or a three-dimensional sensor that can acquire a depth map and/or a three-dimensional point cloud. The image processing device 50 holds a model pattern of a workpiece and can execute image processing of detecting a workpiece by pattern matching between an image of the workpiece during image capture and a model pattern. The visual sensor 70 is assumed to be calibrated, and the image processing device 50 is assumed to hold calibration data defining a relative positional relation between the visual sensor 70 and the robot 30. Thus, a position in an image captured by the visual sensor 70 can be transformed into a position in a coordinate system (such as a robot coordinate system) fixed to a workspace.

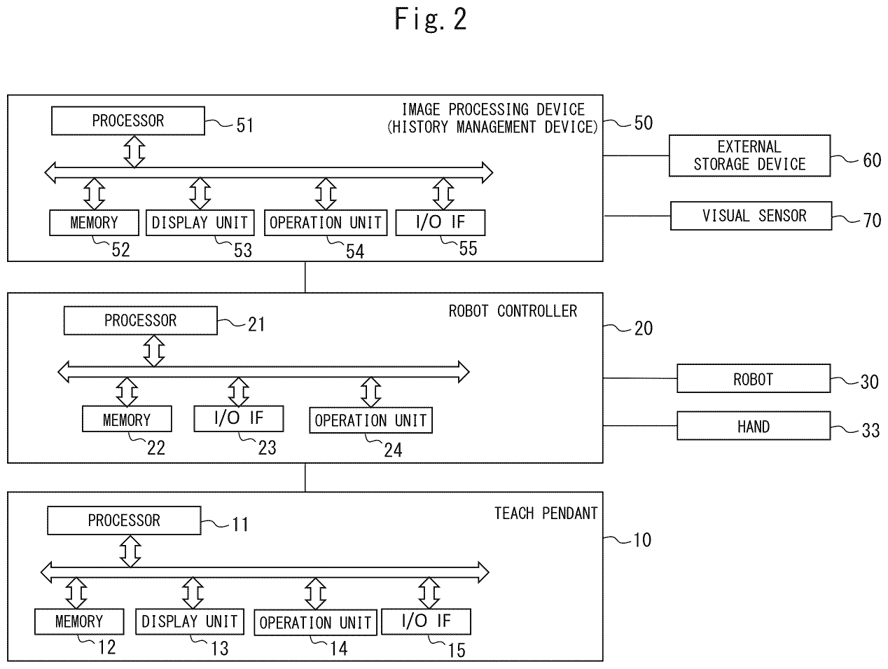

FIG. 2 is a diagram illustrating a hardware configuration example of the image processing device 50, the robot controller 20, and the teach pendant 10. The image processing device 50 may have a configuration as a common computer including a processor 51 connected to a memory 52 [such as a ROM, a RAM (a volatile memory), and/or a nonvolatile memory], a display unit 53, an operation unit 54 including input devices such as a keyboard and a touch panel (software keys), an input-output interface 55, etc. through a bus. The robot controller 20 may have a configuration as a common computer including a processor 21 connected to a memory 22 (such as a ROM, a RAM, and/or a nonvolatile memory), an input-output interface 23, an operation unit 24 including various operation switches, etc. through a bus.

The teach pendant 10 may have a configuration as a common computer including a processor 11 connected to a memory 12 (such as a ROM, a RAM, and/or a nonvolatile memory), a display unit 13, an operation unit 14 including input devices such as a keyboard and a touch panel (software keys), an input-output interface 15, etc. through a bus. Various information processing devices such as a tablet terminal, a smartphone, and a personal computer may be used as a teaching device in place of the teach pendant 10.

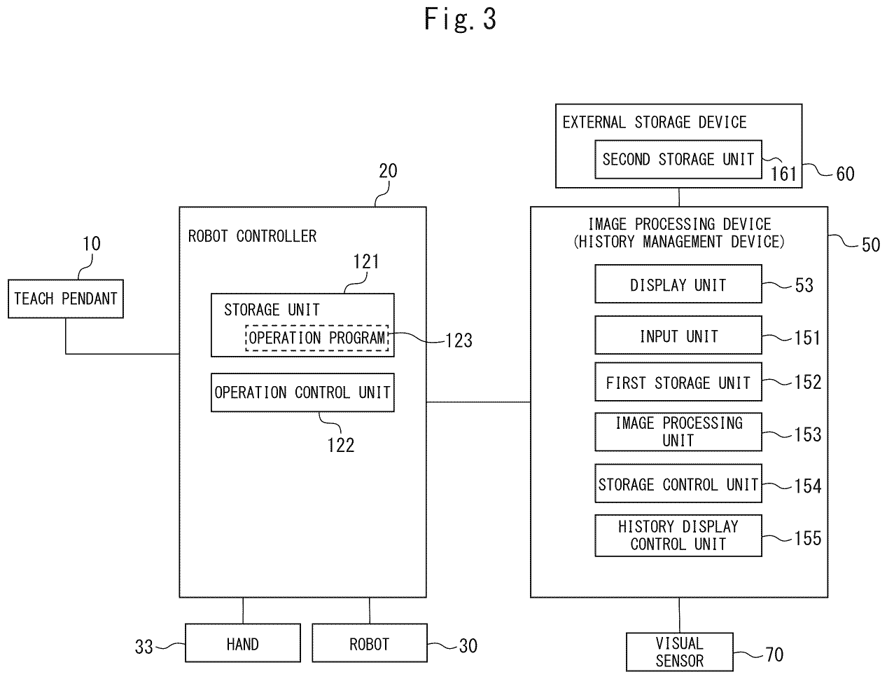

FIG. 3 is a functional block diagram related to the image processing device 50, the external storage device 60, and the robot controller 20. As illustrated in FIG. 3, the robot controller 20 includes a storage unit 121 storing an operation program 123 and various other types of information, and an operation control unit 122. The operation control unit 122 controls the operation of the robot 30 in accordance with the operation program 123 or a command from the teach pendant 10. In other words, the operation control unit 122 interprets the operation program 123 etc., plans a trajectory of the robot, generates a command for controlling each axis of the robot 30, and executes servo control of a servomotor at each axis.

Further, the operation control unit 122 provides machine control information of the robot 30 to the image processing device 50. The machine control information of the robot 30 includes the position (rotation position) of each joint axis and the position and the pose of a predetermined control part (such as a tool center point (TCP)). The image processing device 50 may store therein the machine control information acquired from the robot controller 20 as part of history information about an execution result of processing using the visual sensor 70.

The image processing device 50 includes an input unit 151, a first storage unit 152, an image processing unit 153, a storage control unit 154, and a history display control unit 155. The external storage device 60 includes a second storage unit 161. In FIG. 3, the display unit 53 is included in the image processing device 50.

The input unit 151 has a function of accepting data input through the operation unit 54 (an input device such as a keyboard, a mouse, or a touch panel). The input unit 151 may further have a function of receiving input from another controller and/or a computer through a communication line. The display unit 53 is a display device displaying various pieces of information. The display unit 53 may be integrally formed with a touch panel as the operation unit 54. The image processing unit 153 has a function of performing various types of image processing such as processing of detecting the position and the pose of a workpiece from a captured image by pattern matching.

The first storage unit 152 is a relatively high-speed memory storing history information including an execution result of processing performed by the visual sensor 70 (including a history image and details of the processing execution result) and machine control information at a time of image capture. A term such as high speed or low speed related to a memory indicates a read-write speed. Without being particularly limited, for example, the first storage unit 152 may be configured with a volatile memory such as a DRAM or an SRAM. The first storage unit 152 has a capacity that can store a plurality of pieces of history information. Thus, processing of current image data captured by the visual sensor 70, and transfer of past image capture information from the first storage unit 152 to the second storage unit 161 and deletion thereof from the first storage unit 152 can be simultaneously performed, and therefore delay in the operation of the robot system 100 due to processing related to the first storage unit 152 can be suppressed. Further, the capability to store a plurality of pieces of history information enables, for example, an investigation of an issue to be performed retroactively to a past execution of processing performed by the visual sensor, by using the stored history information.

The second storage unit 161 in the external storage device 60 has a characteristic (i.e., performance as a storage device) different from that of the first storage unit 152. The second storage unit 161 is a memory with a lower speed and a higher capacity relative to those of the first storage unit 152. Without being particularly limited, for example, the second storage unit 161 may be configured with a nonvolatile memory such as a flash memory, a solid state drive (SSD), a hard disk drive, or an optical disk drive. The second storage unit 161 has a capacity that can store image capture information acquired in relatively long-term operation of the robot system 100. The second storage unit 161 may store history information transferred from the first storage unit 152; or history information as an execution result of processing performed by the visual sensor 70 may be directly written into the second storage unit 161.

The second storage unit 161 may store image capture information as data in a format different from that in the first storage unit 152. In this case, the storage control unit 154 may directly store image capture information into the second storage unit 161 as data in a format different from that in a case of storing the information into the first storage unit 152. Alternatively, the storage control unit 154 may convert image capture information read from the first storage unit 152 into data in a different format and write the converted data into the second storage unit. As an example, the second storage unit 161 may store a compressed data file created by compressing text data of image capture information in the first storage unit 152.

The storage control unit 154 executes control related to storage of history information such as storage of history information by the first storage unit 152, storage of history information by the second storage unit 161, and transfer of history information from the first storage unit 152 to the second storage unit 161. The storage control unit 154 causes the first storage unit 152 or the second storage unit 161 to store image data acquired from the visual sensor 70, an execution result of processing using the visual sensor 70, machine control information, etc. in association with each other as one piece of history information.

The storage control unit 154 according to the present embodiment may store history information in accordance with operation procedures as follows.
(a1) History information is stored into the first storage unit 152 every time a processing program using the visual sensor (including image capture) is executed.
(a2) When an amount of data stored in the first storage unit 152 reaches an upper limit or exceeds a predetermined amount of data, history information is transferred to the second storage unit 161 in chronological order, and history information transferred to the second storage unit 161 is deleted from the first storage unit 152.
Through the operations described above, history information temporarily stored in the first storage unit 152 can be completely stored in the second storage unit 161.

The storage control unit 154 may be configured not to automatically perform the aforementioned procedure (a2). In other words, transfer of history information from the first storage unit 152 to the second storage unit 161 may be left to a user operation.

The history display control unit 155 provides a function for an operator to promptly and efficiently check history information stored in the first storage unit 152 and the second storage unit 161. The history display control unit 155 reads history information stored in the first storage unit 152 configured with a relatively high-speed volatile memory and history information stored in the second storage unit 161 configured with a relatively low-speed and high-capacity nonvolatile memory and displays the read information simultaneously on a display screen. Thus, the history display control unit 155 reads history information from both the first storage unit 152 and the second storage unit 161 being memories with different characteristics and simultaneously displays the read information. Thus, history information stored in the first storage unit 152 and the second storage unit 161 with characteristics different from each other can be collectively managed, and checking of and an operation on the history information can be carried out efficiently.

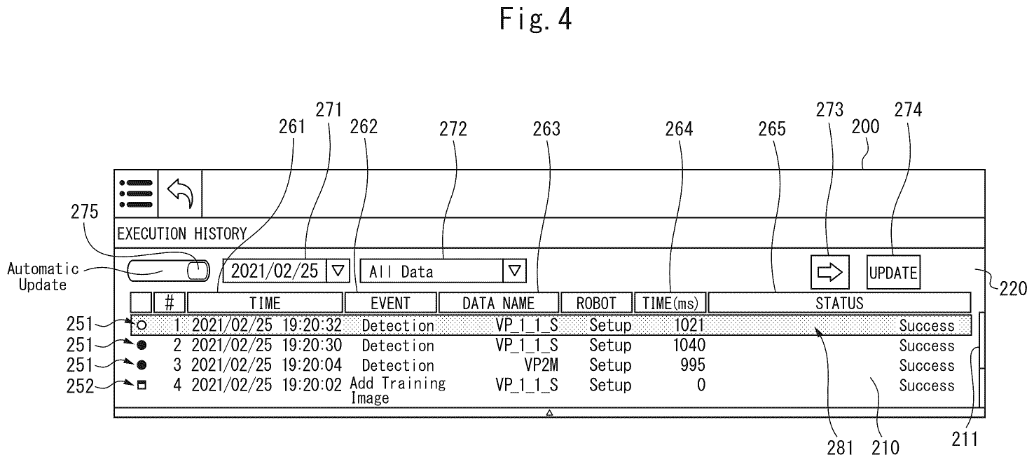

An example of display of history information executed by the history display control unit 155 will be described with reference to FIG. 4. As an example, FIG. 4 is a diagram illustrating a history display screen 200 displayed on the display unit 53 by the history display control unit 155. It is assumed in the operation example described below with reference to FIG. 4 to FIG. 6 that transfer of history information from the first storage unit 152 to the second storage unit 161 is not automatically performed and is left to a user operation.

As illustrated in FIG. 4, the history display screen 200 includes a history information display region 210 where history information is displayed and a command placement region 220 where various command buttons related to display of a history is placed. History information read from the first storage unit 152 and the second storage unit 161 is arranged in accordance with a predetermined rule and is simultaneously displayed in the history information display region 210. While four pieces of history information are displayed in the history information display region 210 in FIG. 4, a fifth and subsequent pieces of history information can be displayed by operating a scroll bar 211.

The history display control unit 155 provides an operation of simultaneously displaying history information stored in the first storage unit 152 and history information stored in the second storage unit 161 by processing as follows. The history display control unit 155 reads history information from each of the first storage unit 152 (a volatile memory) and the second storage unit 161 (a nonvolatile memory) and respectively stores the information into two arrays. An array storing history information from the first storage unit 152 is denoted by M1 (i), and an array storing history information from the second storage unit 161 is denoted by M2 (i). The history display control unit 155 combines the two arrays, rearranges the combined array in accordance with a predetermined rule, and stores the rearranged array into one display array A (i). FIG. 4 illustrates an example of rearranging history information in order of time (in order of execution time of processing) as the predetermined rule.

Furthermore, when generating the display array A (i), the history display control unit 155 adds, to the display array A (i), a flag indicating whether each piece of history information belongs to the first storage unit 152 or the second storage unit 161. Then, the history display control unit 155 displays history information stored in the display array A (i) on the history display screen 200. Further, based on the aforementioned flag, the history display control unit 155 adds, to each piece of history information, an image (mark) indicating which storage unit the information belongs to as identification information. FIG. 4 illustrates a state in which the latest four pieces of history information in the display array A (i) are displayed in the history information display region 210.

In FIG. 4, a mark 251 indicating that information belongs to the first storage unit (a volatile memory) is displayed with respect to the first to third pieces of history information, and a mark 252 indicating that information belongs to the second storage unit (a nonvolatile memory) is added to the fourth piece of history information. The marks 251 and 252 allow a user to instantaneously recognize whether each piece of history information belongs to the first storage unit (a volatile memory) or the second storage unit (a nonvolatile memory).

The history display screen 200 illustrated in FIG. 4 includes an execution time 261, an event 262, a data name 263, a run time 264, status 265, etc. as history information. The execution time 261 represents a time when a processing program is executed by the visual sensor. The event 262 represents the content of the processing performed by the visual sensor 70. The data name 263 represents the processing program name. The run time 264 represents the run time (cycle time) of the processing program. The status 265 represents an execution result of the processing program.

“Detection” in the event 262 field indicates that the content of the processing program is detection processing of a workpiece using the visual sensor. “Add Training Image” in the event 262 indicates that the content of the processing program is processing for adding an image for training related to, for example, pattern matching. “Success” in the status 265 indicates that processing such as detection has normally terminated. For example, when non-detection of a workpiece occurs in the detection processing, “Detection error” is displayed in the status 265 field.

The command placement region 220 includes a date specification field 271 and a display condition specification field 272 for specifying a condition for history information to be displayed in the history information display region 210. When a date is specified in the date specification field 271, the history display control unit 155 displays, in the history information display region 210, only history information having the specified date of the history information stored in the display array A (i). A display condition for history information can be specified in the display condition specification field 272. For example, by specifying “Status: Success” in the display condition specification field 272, only normally terminated processing can be displayed in the history information display region 210. When conditions are specified in both the date specification field 271 and the display condition specification field 272, the history display control unit 155 may extract and display history information based on an AND condition of the specified conditions.

The history display control unit 155 may be configured to limit the number of pieces of history information to be included in the history information display region 210 at a time to a certain number. For example, limiting the number of pieces of history information included in the history information display region 210 at a time to 20 can avoid occurrence of a situation in which many pieces of history information are included in the history information display region 210 at a time and checking becomes complicated. By depressing a button 273 for reading next 20 pieces of history information into the history information display region 210, an operator can include the next 20 pieces of history information into the history information display region 210.

An update button 274 is further placed in the command placement region 220. When the update button 274 is depressed, the history display control unit 155 newly reads history information from the first storage unit 152 and the second storage unit 161 and updates the display content in the history information display region 210.

Examples of the predetermined rule in a case of the history display control unit 155 rearranging history information read from both the first storage unit 152 and the second storage unit 161 may include rearrangement based on various parameters included in history information in addition to the example of arrangement based on execution time illustrated in FIG. 4. The history display control unit 155 may employ one or more of the following as predetermined rules for rearrangement.
(b1) The history information is rearranged based on the execution time of processing.
(b2) History information is classified and rearranged based on status indicating the execution result of processing.
(b3) History information is classified and rearranged based on information indicating the content of processing (“EVENT” in FIG. 4).
(b4) History information is classified and rearranged based on the program name of processing.
(b5) History information is rearranged based on the run time of a processing program. For example, history information may be grouped by one of the aforementioned rules (b2), (b3), and (b4), and then the history information may be arranged in order of execution time in each group.

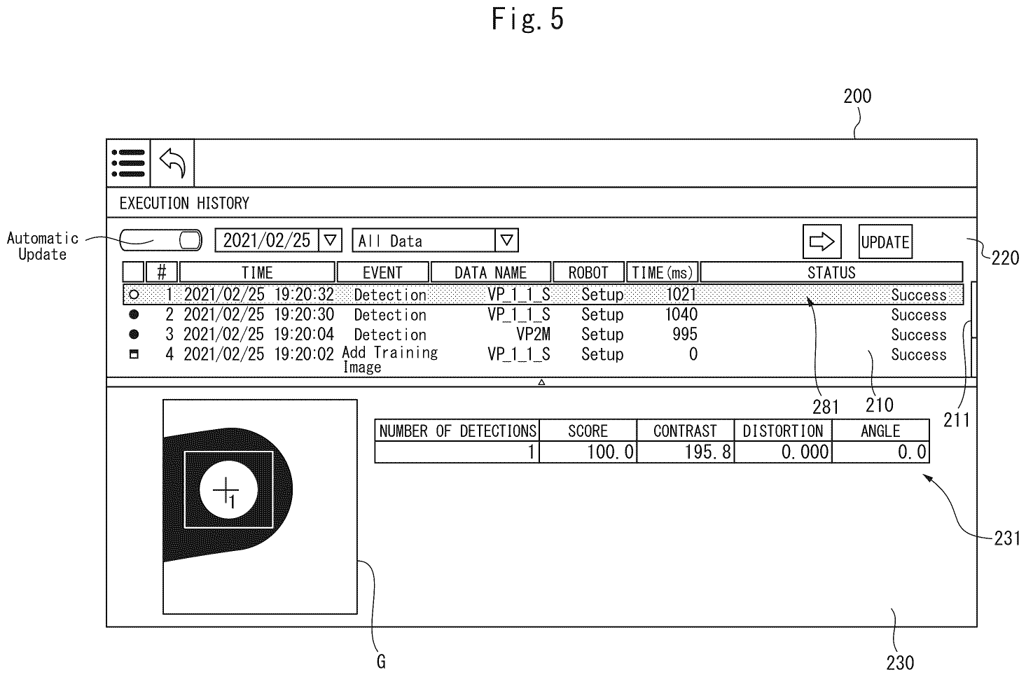

When a user desires to check a history image and/or details of a detection result included in history information, the user can display the information by performing an operation of selecting history information in the history information display region 210. For example, a history image may be displayed by an operation such as selecting history information in the history information display region 210 and operating a predetermined button or double-clicking history information in the history information display region 210. FIG. 5 illustrates a state in which a history image display region 230 showing a history image and details of a detection result is displayed by selecting history information in the history information display region 210. It is assumed that the first piece of history information 281 in the history information display region 210 in FIG. 4 is selected and a history image and details of an execution result that are related to the selected history information 281 are displayed in the history image display region 230.

As illustrated in FIG. 5, the history image display region 230 includes a history image G and a detailed detection result 231. The detection result 231 includes various parameters being the number of detected workpieces, the score of pattern matching, contrast, distortion of the detected image, and the rotation angle. By checking the content of the history image display region 230 as needed, the operator may determine whether to store the history information into the second storage unit 161.

While an example of displaying detailed information including a history image etc. with regard to one piece of selected history information is illustrated in FIG. 5, a configuration in which two or more pieces of history information can be selected in the history information display region 210 and detailed information including history images related to the two or more pieces of selected history information is simultaneously displayed on a display screen may be employed. In this case, the operator can simultaneously check a history image stored in the first storage unit 152 and a history image stored in the second storage unit 161 (i.e., history images respectively stored in memory devices with different characteristics) on the display screen. By simultaneously displaying a plurality of history images, the operator can readily compare the images and, for example, can promptly and appropriately specify an issue in a case of non-detection and determine whether to store history information in the first storage unit 152 into the second storage unit 161.

Further, the history display screen 200 includes a switching button 275 for switching between an “automatic update mode” and an “update suspension mode.” The automatic update mode is an operation mode in which the history display control unit 155 automatically repeats read-in and display of history information from the first storage unit 152 and the second storage unit 161 (i.e., update of history information). As an example, the repetition period may be on the order of several seconds. The update suspension mode is an operation mode in which read-in of history information from the first storage unit (a volatile memory) is suspended. In other words, overwriting into the display array A (i) from the first storage unit (a volatile memory) is suspended. The automatic update mode is set in the history display screen 200 in FIG. 4 and FIG. 5.

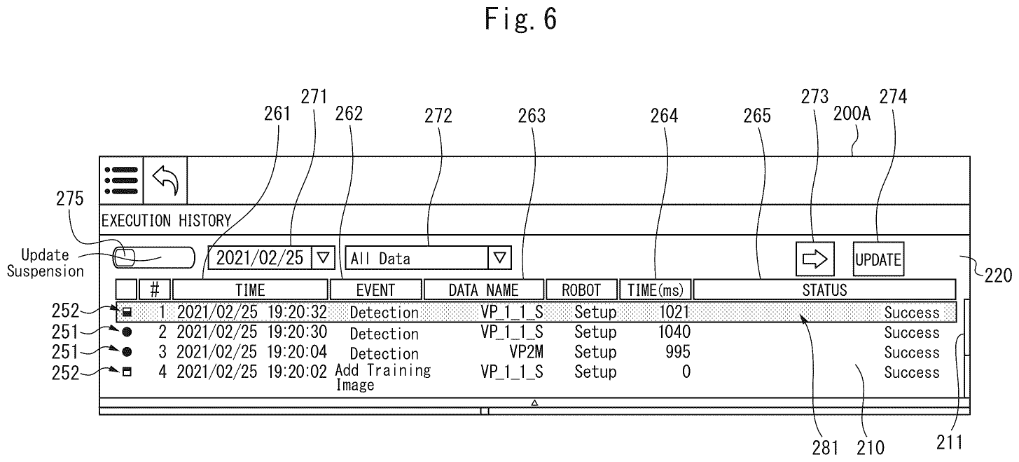

FIG. 6 illustrates a history display screen 200A in a state of being set to the update suspension mode by operating the switching button 275 on the history display screen 200 in FIG. 4 or FIG. 5. Read-in of history information from the first storage unit 152 is not newly performed in the update suspension mode. Thus, on the history display screen 200A, the state of the history information read from the first storage unit 152 (a volatile memory) is maintained without being updated. In this case, a user has ample time to check the history information from the first storage unit 152 (a volatile memory) displayed on the history display screen 200A.

FIG. 6 illustrates a state in the update suspension mode in which, by a user selecting a first piece of history information and performing an operation of transferring the information to the second storage unit, a mark indicating a storage location of the first piece of history information is changed to the mark 252 indicating that the information belongs to the second storage unit 161.

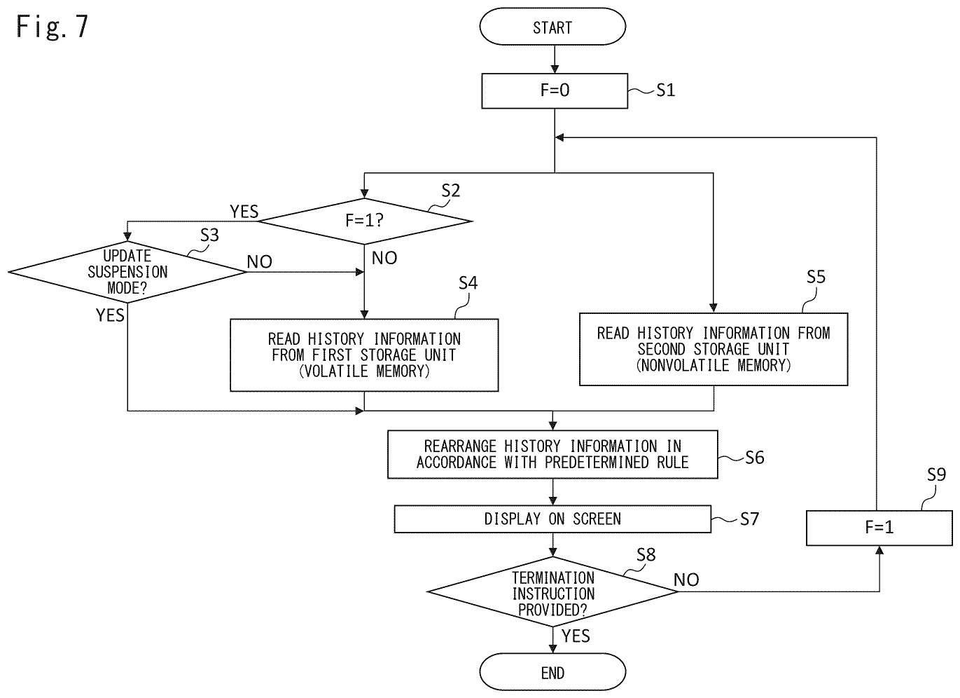

FIG. 7 illustrates a flowchart illustrating history information display processing including the automatic update mode and the update suspension mode that are described above. For example, this history information display processing is started by a predetermined user operation and is executed under the control of the history display control unit 155 (i.e., the processor 51 in the image processing device 50). In step S1, a flag F used for controlling the processing is initialized. It is assumed that the automatic update mode is set in a state of the history display processing being initially started.

Since F=0, a NO determination is made in step S2, and processing of reading history information from the first storage unit 152 (a volatile memory) (step S4) and processing of reading history information from the second storage unit 161 (a nonvolatile memory) (step S5) are executed in parallel.

Next, the history display control unit 155 rearranges the history information read from both the first storage unit 152 and the second storage unit 161 in accordance with a predetermined rule (step S6) and displays the rearranged information on the display unit 53 (step S7). When a user operation for terminating this history display processing is not performed (S8: NO), the history display control unit 155 repeats the processing from steps S2 and S5 at predetermined periods.

Since F=1 is set (step S9) in the second or subsequent round of the processing, a YES determination is made in step S2, and whether the update suspension mode is set is determined (step S3). When the update suspension mode is set (S3: YES), step S4 is skipped. When the update suspension mode is not set (i.e., the automatic update mode is set) (S3: NO), read-in of history information from the first storage unit 152 is performed (step S4).

Through the aforementioned history display processing, history display in the automatic update mode and the update suspension mode that are described with reference to FIG. 4 to FIG. 6 is executed.

While an operation example of repeating read-in from both the first storage unit 152 and the second storage unit 161 in the automatic update mode is illustrated in FIG. 7, read-in from the second storage unit 161 in that mode may be limited to the first time, and the display content may be updated by repeating only read-in from the first storage unit 152.

As described above, according to the present embodiment, history information read from the first storage unit 152 and the second storage unit 161 that are different in performance is simultaneously displayed on the display screen, and therefore, a user can collectively manage history information ranging from past history information recorded in the robot system 100 to latest history information about an execution result of current processing. In other words, operations such as checking history information and transferring required history information to a nonvolatile memory can be carried out efficiently.

When all history information stored in the first storage unit 152 (a volatile memory) is stored into the second storage unit 161 (a nonvolatile memory) in a case of image data being included in history information, the capacity of the second storage unit 161 is used in large amounts, and storage into the second storage unit 161 takes considerable time; however, according to the aforementioned embodiment, an operator can selectively transfer required history information from the first storage unit 152 to the second storage unit 161 and store the information in the second storage unit 161 while checking the aforementioned history display screen 200 or 200A. Thus, the storage capacity of the second storage unit 161 can be saved. Selection of history information on the history display screen 200 or 200A and transfer of the selected history information from the first storage unit 152 to the second storage unit 161 may be performed under the control of the history display control unit 155.

While the present invention has been described above by using the typical embodiments, it may be understood by a person skilled in the art that changes, and various other changes, omissions, and additions can be made to the aforementioned embodiments without departing from the scope of the present invention.

The function as the history management device according to the aforementioned embodiment is applicable to various industrial machine systems configured to save a history into a first storage unit (such as a volatile memory) and store a history transferred from the first storage unit into a second storage unit (such as a nonvolatile memory) with a characteristic different from the first storage unit.

While the aforementioned embodiment is illustrative of a configuration in which the image processing device 50 as the history management device is connected to the external storage device 60 as the second storage unit 161, a nonvolatile memory functioning as the second storage unit 161 may be incorporated into the image processing device 50 as the history management device.

While a configuration example in which the function as the history management device is embedded in the image processing device 50 is described in the aforementioned embodiment, the aforementioned example is illustrative, and the function as the history management device may be provided in another device in the robot system. For example, the function as the history management device may be provided in the teach pendant. For example, the teach pendant 10 may be provided with the function as the history display control unit 155 and may read history information from the first storage unit 152 in the image processing device 50 and the second storage unit 161 in the external storage device 60 and perform history display on the display unit 13 in the teach pendant 10. Various types of information described in the aforementioned embodiment with regard to history information are examples, and history information may be information including at least one item out of a captured image, information about the content or an execution result of processing, and machine control information.

The update suspension mode according to the aforementioned embodiment is implemented in a form of suspending, by the history display control unit 155, further read-in of history information from the first storage unit 152 (a volatile memory). Alternatively, the update suspension mode may be implemented in a form of suspending writing of history information into the first storage unit 152 (a volatile memory) by the storage control unit 154.

The functional blocks in the robot controller and the image processing device illustrated in FIG. 3 may be provided by executing various types of software stored in a storage device by the processors in the devices or may be provided by a configuration mainly based on hardware such as an application specific integrated circuit (ASIC).

A program for executing various types of processing such as the history information display processing according to the aforementioned embodiment may be recorded on various computer-readable recording media (such as, semiconductor memories such as a ROM, an EEPROM, and a flash memory, a magnetic recording medium, and optical disks such as a CD-ROM and a DVD-ROM).

### REFERENCE SIGNS LIST

1 Workpiece
2 Workbench
10 Teach pendant
20 Robot controller
30 Robot
33 Hand
50 Image processing device
11, 21, 51 Processor
12, 22, 52 Memory
13, 53 Display unit
14, 24, 54 Operation unit
15, 23, 55 Input-output interface
60 External storage device
70 Visual sensor
100 Robot system
121 Storage unit
122 Operation control unit
123 Operation program
151 Input unit
152 First storage unit
153 Image processing unit
154 Storage control unit
155 History display control unit
161 Second storage unit
200, 200A History display screen
210 History information display region
220 Command placement region
230 History image display region

1. A history management device for managing history information about an execution result of predetermined processing performed by an industrial machine, the history management device comprising:
a display unit; and
a history display control unit configured to control display of the history information on the display unit,
wherein the history display control unit reads the history information from both a first storage unit storing the history information and a second storage unit with a characteristic different from that of the first storage unit, the second storage unit storing the history information, and simultaneously displays the read history information on the display unit.

2. The history management device according to claim 1, wherein the first storage unit includes a storage device with a read-write speed greater than that of the second storage unit.

3. The history management device according to claim 1, wherein the second storage unit includes a storage device with a storage capacity greater than that of the first storage unit.

4. The history management device according to claim 1, wherein the first storage unit includes a volatile memory, and the second storage unit includes a nonvolatile memory.

5. The history management device according to claim 1, wherein, for each piece of the history information displayed on the display unit, the history display control unit displays identification information indicating whether the history information belongs to the first storage unit or the second storage unit.

6. The history management device according to claim 5, wherein, when the history information is transferred from the first storage unit to the second storage unit, the history display control unit changes the identification information displayed for the history information from a display indicating that the history information belongs to the first storage unit to a display indicating that the history information belongs to the second storage unit.

7. The history management device according to claim 1, wherein the history display control unit has an automatic update mode of repeatedly executing read-in of the history information from at least the first storage unit and, every time the history information is newly read from the first storage unit, updating a display content of the history information on the display unit by using the newly read history information.

8. The history management device according to claim 7, wherein the history display control unit has an update suspension mode of suspending further read-in of the history information from the first storage unit.

9. The history management device according to claim 1, wherein the history display control unit rearranges the history information read from the first storage unit and the second storage unit in accordance with a predetermined rule and displays the rearranged history information on the display unit.

10. The history management device according to claim 9, wherein the predetermined rule includes at least one of the following:
(1) rearranging the history information, based on an execution time of the processing;
(2) classifying and rearranging the history information, based on status indicating an execution result of the processing;
(3) classifying and rearranging the history information, based on information indicating a content of the processing;
(4) classifying and rearranging the history information, based on a program name of the processing; and
(5) rearranging the history information, based on a run time of a program of the processing.

11. The history management device according to claim 1, wherein the history display control unit displays, on the display unit, history information meeting a predetermined display condition in the history information read from the first storage unit and the second storage unit.

12. The history management device according to claim 1, wherein the history display control unit transfers, to the second storage unit, selected history information out of a plurality of pieces of the history information being simultaneously displayed on the display unit and belonging to the first storage unit.

13. The history management device according to claim 1, wherein the predetermined processing is processing using a visual sensor.

14. The history management device according to claim 13, wherein the history display control unit simultaneously displays, on the display unit, history images included in two or more pieces of selected history information of the history information read from the first storage unit and the second storage unit.

15. A non-transitory computer readable storage medium storing instructions that, when executed by a processor of a computer, cause the processor to perform
processing of reading history information about an execution result of processing performed by an industrial machine from both a first storage unit storing the history information and a second storage unit with a characteristic different from that of the first storage unit, the second storage unit storing the history information, rearranging the read history information in accordance with a predetermined rule, and simultaneously displaying the rearranged history information on a display screen.
